(19) United States
(12) Patent Application Publication
(10) Pub. No.: US 2026/0029867 A1
(43) Pub. Date: Jan. 29, 2026

(54) ELECTRONIC DEVICE

(71) Applicant: Samsung Display Co., Ltd., Yongin-si (KR)

(72) Inventor: EUNGKWAN LEE, Yongin-si (KR)

(21) Appl. No.: 19/201,212

(22) Filed: May 7, 2025

(30) Foreign Application Priority Data
Jul. 29, 2024 (KR) 10-2024-0100335

(51) Int. Cl. G06F 3/041; G06F 3/044

(52) U.S. Cl. CPC G06F 3/04164; G06F 3/0445

(57) ABSTRACT

Disclosed is an electronic device including a first sensor conductive layer including first conductive patterns spaced apart from each other, and including a first auxiliary electrode, a second auxiliary electrode, and a third auxiliary electrode arranged along a first direction, and insulated electrically, a connection line extending along the first direction, and connected to the first auxiliary electrode, and sensing lines spaced apart from each other, a second sensor conductive layer above the first sensor conductive layer, and including second conductive patterns spaced apart from each other and including a first sensing electrode, a second sensing electrode, and a third sensing electrode arranged along the first direction, insulated electrically, and respectively connected to the sensing lines, the third sensing electrode being connected to the connection line, and a sensor insulating layer between the first sensor conductive layer and the second sensor conductive layer.

### CROSS-REFERENCE TO RELATED APPLICATION

The present application claims priority to, and the benefit of, Korean Patent Application No. 10-2024-0100335, filed on Jul. 29, 2024, in the Korean Intellectual Property Office, the entire disclosure of which is incorporated herein by reference.

### BACKGROUND

Embodiments of the present disclosure described herein relate to an electronic device with improved touch sensitivity.

Multimedia devices, such as televisions, mobile phones, tablets, navigation systems, and game consoles, include an electronic device that display images to a user through a display screen. The electronic device may include a display layer that generates an image, and an input sensor that senses a user's touch.

The input sensor may include a conductor that senses an external input, and the conductor of the input sensor located on the display layer may affect the light output efficiency of the electronic device or the external light reflectance of the electronic device.

### SUMMARY

Embodiments of the present disclosure provide an electronic device with improved touch sensitivity.

According to an aspect of the present disclosure, an electronic device includes a first sensor conductive layer including first conductive patterns spaced apart from each other, and including a first auxiliary electrode, a second auxiliary electrode, and a third auxiliary electrode arranged along a first direction, and insulated electrically, a connection line extending along the first direction, and connected to the first auxiliary electrode, and sensing lines spaced apart from each other, a second sensor conductive layer above the first sensor conductive layer, and including second conductive patterns spaced apart from each other and including a first sensing electrode, a second sensing electrode, and a third sensing electrode arranged along the first direction, insulated electrically, and respectively connected to the sensing lines, the third sensing electrode being connected to the connection line, and a sensor insulating layer between the first sensor conductive layer and the second sensor conductive layer.

The first sensing electrode, the second sensing electrode, and the third sensing electrode may respectively overlap the first auxiliary electrode, the second auxiliary electrode, and the third auxiliary electrode.

Areas of the first sensing electrode, the second sensing electrode, and the third sensing electrode may be larger than areas of the first auxiliary electrode, the second auxiliary electrode, and the third auxiliary electrode.

The first sensing electrode, the second sensing electrode, and the third sensing electrode may be configured to operate in a self-capacitance mode.

The connection line may include at least one bent portion, including a first part extending in a second direction crossing the first direction, and a second part connected to the first part, extending in the first direction, and having at least a portion overlapping the second sensing electrode.

The connection line, the first auxiliary electrode, the second auxiliary electrode, and the third auxiliary electrode may include a same material.

The connection line may penetrate the sensor insulating layer, and may be connected to the second conductive patterns.

The sensing lines may respectively include portions that penetrate the sensor insulating layer, and that are respectively connected to the first sensing electrode, the second sensing electrode, and the third sensing electrode.

Areas of the first sensing electrode, the second sensing electrode, and the third sensing electrode may be identical.

An identical driving voltage may be configured to be applied to the second sensing electrode, the third sensing electrode, and the first auxiliary electrode when the first sensing electrode is driven.

The first auxiliary electrode and the third sensing electrode may be configured to be driven concurrently.

According to another aspect of the present disclosure, an electronic device includes a first sensing electrode, a second sensing electrode, and a third sensing electrode at an identical layer, and arranged along one direction, a first auxiliary electrode, a second auxiliary electrode, and a third auxiliary electrode at an identical layer, and arranged along the one direction, a sensor insulating layer between the first sensing electrode and the first auxiliary electrode, a connection line extending along the one direction, and connected to the first auxiliary electrode and the third sensing electrode, and sensing lines respectively connected to the first sensing electrode, the second sensing electrode, and the third sensing electrode, and spaced apart from each other.

The connection line, the first auxiliary electrode, the second auxiliary electrode, and the third auxiliary electrode may be at an identical layer.

The sensing lines, the connection line, the first auxiliary electrode, the second auxiliary electrode, and the third auxiliary electrode may be at an identical layer.

The first auxiliary electrode, the second auxiliary electrode, and the third auxiliary electrode may respectively partially overlap the first sensing electrode, the second sensing electrode, and the third sensing electrode.

Areas of the first sensing electrode, the second sensing electrode, and the third sensing electrode may be larger than areas of the first auxiliary electrode, the second auxiliary electrode, and the third auxiliary electrode.

The first sensing electrode, the second sensing electrode, and the third sensing electrode may be configured to operate in a self-capacitance mode.

The connection line, the first auxiliary electrode, the second auxiliary electrode, and the third auxiliary electrode may include a same material.

An identical driving voltage may be configured to be applied to the second sensing electrode, the third sensing electrode, and the first auxiliary electrode when the first sensing electrode is driven.

The first auxiliary electrode and the third sensing electrode may be configured to be driven concurrently.

### BRIEF DESCRIPTION OF THE DRAWINGS

The above and other aspects of the present disclosure will become apparent by describing in detail embodiments thereof with reference to the accompanying drawings.

FIG. 1 is a perspective view of an electronic device according to one or more embodiments of the present disclosure.

FIG. 2 is a cross-sectional view of an electronic device according to one or more embodiments of the present disclosure.

FIG. 3 is a plan view of a portion of an electronic device according to one or more embodiments of the present disclosure. FIG. 4 is a plan view of an input-sensing layer according to one or more

embodiments of the present disclosure.

FIG. 5 is a cross-sectional view of an electronic device according to one or more embodiments of the present disclosure.

FIG. 6 is an enlarged view of a portion of an input-sensing layer according to one or more embodiments of the present disclosure.

FIG. 7 is a cross-sectional view of an electronic device according to one or more embodiments of the present disclosure.

FIG. 8 is an enlarged view of a portion of an input-sensing layer according to one or more embodiments of the present disclosure.

FIG. 9 is a cross-sectional view of an electronic device according to one or more embodiments of the present disclosure.

FIG. 10 is a schematic diagram illustrating a sensor structure of an electronic device according to one or more embodiments of the present disclosure.

FIG. 11 is a block diagram illustrating an input-sensing layer and a driver according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object.

In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

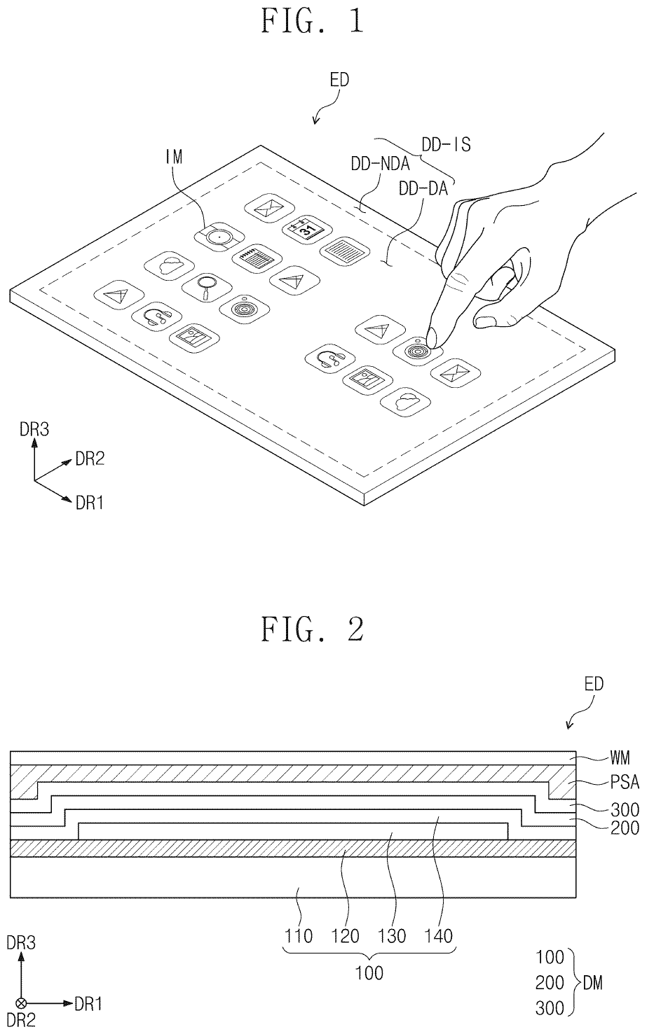

FIG. 1 is a perspective view of an electronic device ED according to one or more embodiments of the present disclosure.

As illustrated in FIG. 1, the electronic device ED may display an image through a display surface DD-IS. The display surface DD-IS may have a rectangular shape with long sides extending in a first direction DR1, and short sides extending in a second direction DR2 that crosses the first direction DR1 on a plane. However, the display surface DD-IS is not limited thereto, but may have various shapes, such as a circular shape and a polygonal shape.

A third direction DR3 may be defined as a direction substantially perpendicular to a plane defined by the first direction DR1 and the second direction DR2. A front surface (or an upper surface) and a rear surface (or a lower surface) of each member constituting the electronic device ED may oppose each other in the third direction DR3, and normal directions of the front surface and the rear surface, respectively, may be substantially parallel to the third direction DR3. A separation distance between the front surface and the rear surface defined along the third direction DR3 may correspond to the thickness of the member.

In this specification, “on a plane” may be defined as a state viewed in the third direction DR3. That is, “on a plane” may be described with reference to the plane defined by the first direction DR1 and the second direction DR2. In this specification, “in a cross-section” may be defined as a state viewed in the first direction DR1 or the second direction DR2. Meanwhile, directions indicated by the first to third directions DR1, DR2, and DR3 are relative concepts and may be converted to other directions.

In one or more embodiments of the present disclosure, the electronic device ED having a flat display surface is illustrated, but is not limited thereto. The electronic device ED may include a curved display surface, or a three-dimensional display surface. The three-dimensional display surface may include a plurality of display areas pointing in different directions, and may include, for example, a bended display surface. The electronic device ED may be a flexible electronic device. The flexible electronic device may be a foldable electronic device which is capable of being folded.

The electronic device ED that may be applied to a tablet terminal is illustrated. Electronic modules, a camera module, a power module, etc. mounted on a main board may be located in a bracket, or a case, etc. together with the electronic device ED to form a tablet terminal. The electronic device ED according to the present disclosure may be applied to large electronic devices, such as televisions and monitors, and small-to medium-sized electronic devices, such as cell phones, car navigation systems, game consoles, smartwatches, etc.

As illustrated in FIG. 1, the display surface DD-IS includes an image area DD-DA on which an image is displayed, and a bezel area DD-NDA adjacent to the image area DD-DA. The bezel area DD-NDA is an area where an image is not displayed. FIG. 1 illustrates icon images as an example of images.

As illustrated in FIG. 1, the image area DD-DA may have a substantially quadrangular shape. The “substantially quadrangular shape” includes not only a quadrangular shape in a mathematical sense, but also a quadrangular shape in which no vertex is defined in a vertex area (or a corner area) and the boundary of a curve is defined.

The bezel area DD-NDA may surround the image area DD-DA (e.g., in plan view). However, the bezel area DD-NDA is not limited thereto, and the shape of the bezel area DD-NDA may be modified. For example, the bezel area DD-NDA may be located on only one side of the image area DD-DA.

FIG. 2 is a cross-sectional view of the electronic device ED according to one or more embodiments of the present disclosure.

The electronic device ED may include a display module DM and a window WM located on the display module DM. The display module DM and the window WM may be coupled to each other by an adhesive layer PSA. According to one or more embodiments of the present disclosure, the window WM may be formed in a coating method, and may be in contact with the display module DM, and in this case, the adhesive layer PSA may be omitted.

The display module DM may include a display layer 100, an input-sensing layer 200, and an optical layer 300. The display layer 100 may include a base layer 110, a driving element layer 120, a light-emitting element layer 130, and an encapsulation layer 140.

The base layer 110 may be a flexible substrate capable of bending, folding, rolling, etc. The base layer 110 may be a glass substrate, a metal substrate, or a polymer substrate, etc. However, the present disclosure is not limited thereto, and the base layer 110 may be an inorganic layer, an organic layer, or a composite material layer.

The base layer 110 may have a multi-layer structure. For example, the base layer 110 may include a first synthetic resin layer, a second synthetic resin layer, and inorganic layers located therebetween. Each of the first synthetic resin layer and the second synthetic resin layer may include a polyimide-based resin, but is not particularly limited thereto.

The driving element layer 120 may be located on the base layer 110. The driving element layer 120 may include a plurality of insulating layers, a plurality of semiconductor patterns, a plurality of conductive patterns, and signal lines, etc. The driving element layer 120 may include a driving circuit of a pixel.

The light-emitting element layer 130 may be located on the driving element layer 120. The light-emitting element layer 130 may include a light-emitting element. For example, the light-emitting element may include an organic light-emitting material, an inorganic light-emitting material, an organic-inorganic light-emitting material, a quantum dot, a quantum rod, a micro LED, or a nano LED.

The encapsulation layer 140 may be located on the light-emitting element layer 130. The encapsulation layer 140 may protect the light-emitting element layer 130 (e.g., the light-emitting element) from foreign substances, such as moisture, oxygen, and dust particles. The encapsulation layer 140 may include at least one encapsulating inorganic layer. The encapsulation layer 140 may include a stacked structure of a first encapsulating inorganic layer/an encapsulating organic layer/a second encapsulating inorganic layer.

The input-sensing layer 200 may be located directly on the display layer 100. The input-sensing layer 200 may detect an input of a user, for example, in an electromagnetic induction method and/or a capacitance method. The display layer 100 and the input-sensing layer 200 may be formed through a continuous process. Here, “located directly” may mean that no third component is located between the input-sensing layer 200 and the display layer 100. For example, a separate adhesive layer may not be located between the input-sensing layer 200 and the display layer 100.

The optical layer 300 reduces the reflectance of external light incident from the upper side of the window WM. The optical layer 300 according to one or more embodiments of the present disclosure may include a retarder and a polarizer. The retarder may be of film type or liquid crystal coating type and may include a λ/2 retarder and/or a λ/4 retarder. The polarizer may also be of film type or liquid crystal coating type. The film type may include a stretchable synthetic resin film, and the liquid crystal coating type may include liquid crystals arranged in an array (e.g., a predetermined array). The retarder and the polarizer may further include protective films. The retarder and the polarizer themselves or a protective film thereof may be defined as a base layer of the optical layer 300.

The optical layer 300 according to one or more embodiments of the present disclosure may include color filters. The color filters have an arrangement (e.g., a predetermined arrangement). The arrangement of the color filters may be determined by considering light-emitting colors of pixels included in the display layer 100. The optical layer 300 may further include a black matrix adjacent to the color filters. The optical layer 300 including the color filters may be located directly on the display layer 100.

The window WM according to one or more embodiments of the present disclosure may include a base layer and a light-blocking pattern. The base layer may include a glass substrate and/or a synthetic resin film, etc. The light-blocking pattern partially may overlap the base layer. The light-blocking pattern may be located on the rear surface of the base layer, and may substantially define the bezel area DD-NDA (see FIG. 1) of the electronic device ED. An area where the light-blocking pattern is not located may define the image area DD-DA of the electronic device ED (see FIG. 1).

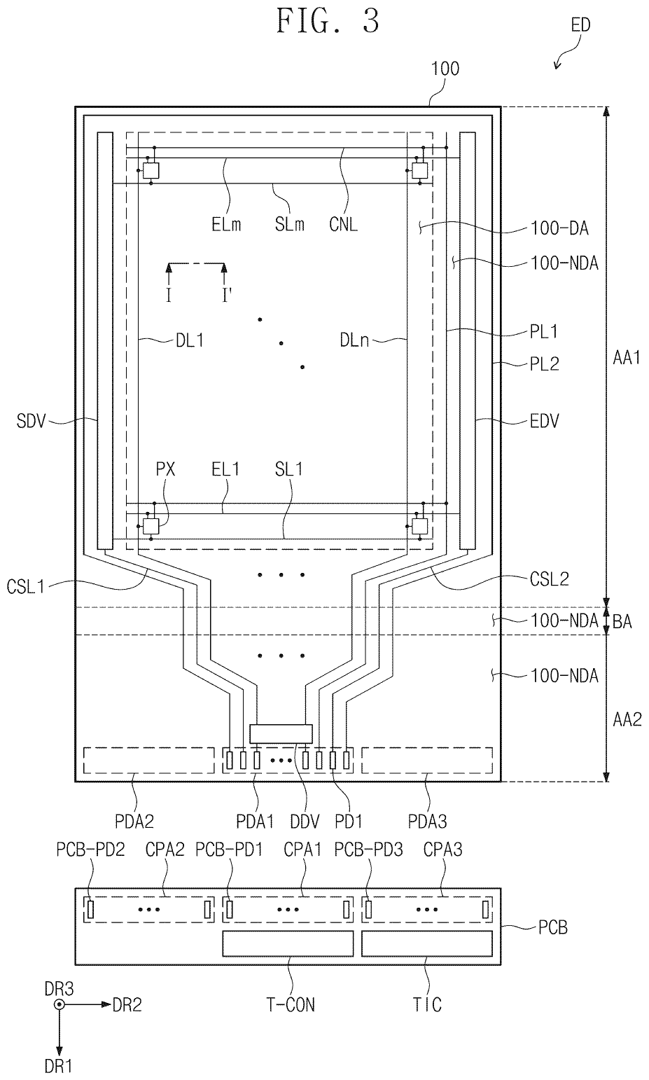

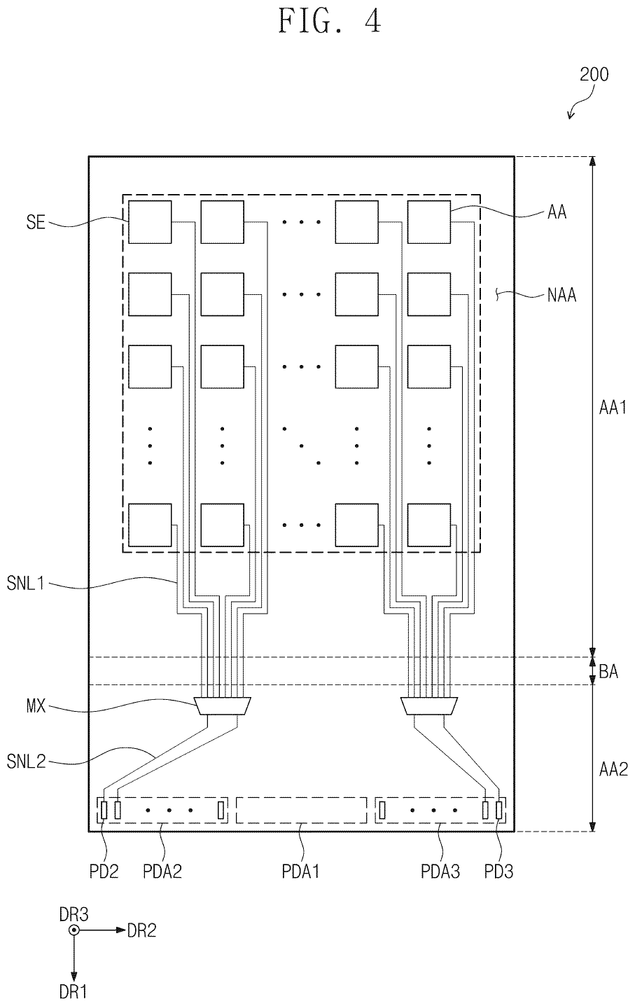

FIG. 3 is a plan view of a portion of the electronic device ED according to one or more embodiments of the present disclosure.

Referring to FIG. 3, the electronic device ED may include the display layer 100, a printed circuit board PCB, a timing controller T-CON, and a sensor driver TIC.

The display layer 100 may be a flexible display panel. The display layer 100 may extend further in the first direction DR1 than in the second direction DR2. For example, the display layer 100 may have a rectangular shape with long sides extending in the first direction DR1, and short sides extending in the second direction DR2.

The display layer 100 may include a first area AA1, a second area AA2, and a bending area BA arranged between the first area AA1 and the second area AA2. The bending area BA may extend in the second direction DR2, and the first area AA1, the bending area BA, and the second area AA2 may be arranged in the first direction DR1.

The first area AA1 may have long sides that extend in the first direction DR1, and that are opposite to each other in the second direction DR2. The first area AA1 may include a display area 100-DA, and a non-display area 100-NDA around the display area 100-DA. The non-display area 100-NDA may surround the display area 100-DA (e.g., in plan view). The display area 100-DA may be defined as an area that is able to display an image IM (see FIG. 1). When viewed on a plane, the display area 100-DA may overlap the image area DD-DA (see FIG. 1). The non-display area 100-NDA may be defined as an area that does not display the image IM (see FIG. 1). When viewed on a plane, the non-display area 100-NDA may overlap the bezel area DD-NDA, (see FIG. 1).

The display layer 100 may include a plurality of pixels PX, a plurality of scan lines SL1 to SLm, a plurality of data lines DL1 to DLn, a plurality of light-emitting lines EL1 to ELm, a first control line CSL1, a second control line CSL2, a first power line PL1, a second power line PL2, connection lines CNL, a plurality of first pads PD1, a scan driver SDV, a data driver DDV, and a light-emitting driver EDV.

The scan driver SDV and the light-emitting driver EDV may be located in the non-display area 100-NDA. For example, the scan driver SDV and the light-emitting driver EDV may be located in the non-display area 100-NDA respectively adjacent to the long sides of the first area AA1. The data driver DDV may be located in the second area AA2. The data driver DDV may be manufactured in the form of an integrated circuit chip, and may be mounted on the second area AA2.

The scan lines SL1 to SLm may extend in the second direction DR2, and may be connected to the scan driver SDV. The data lines DL1 to DLn may extend in the first direction DR1 in the first area AA1, extend to the second area AA2 through the bending area BA, and may be connected to the data driver DDV. The light-emitting lines EL1 to Elm may extend in the second direction DR2, and may be connected to the light-emitting driver EDV.

The first power line PL1 may extend in the first direction DR1, and may be located in the non-display area 100-NDA. The first power line PL1 may be located between the display area 100-DA and the light-emitting driver EDV. However, the first power line PL1 is not limited thereto, but may be located between the display area 100-DA and the scan driver SDV.

The first power line PL1 may extend to the second area AA2 via the bending area BA. When viewed on a plane, the first power line PL1 may extend toward the lower end of the second area AA2. The first power line PL1 may receive a first voltage.

The second power line PL2 may be located in the non-display area 100-NDA facing the second area AA2 so as to be placed between a portion of the non-display area 100-NDA adjacent to the long sides of the first area AA1 and the display area 100-DA. The second power line PL2 may be located at a side and may be outside the scan driver SDV and the light-emitting driver EDV in plan view.

The second power line PL2 may extend to the second area AA2 via the bending area BA. The second power line PL2 may extend in the first direction DR1 in the second area AA2, with the data driver DDV placed between opposite end portions of the second power line PL2. When viewed on a plane, the second power line PL2 may extend toward the lower end of the second area AA2.

The second power line PL2 may receive a second voltage having a voltage level that is lower than the first voltage. For convenience of explanation, a connection relationship is not shown, but the second power line PL2 may extend to the display area 100-DA, and may be connected to the pixels PX, and the second voltage may be provided to the pixels PX through the second power line PL2.

The connection lines CNL may extend in the second direction DR2, and may be arranged in the first direction DR1. The connection lines CNL may be connected to the first power line PL1 and the pixels PX. The first voltage may be applied to the pixels PX through the first power line PL1 and the connection lines CNL, which are connected to each other.

The first control line CSL1 may be connected to the scan driver SDV, and may extend toward the lower end of the second area AA2 via the bending area BA. The second control line CSL2 may be connected to the light-emitting driver EDV, and may extend toward the lower end of the second area AA2 via the bending area BA. The data driver DDV may be located between the first control line CSL1 and the second control line CSL2.

A first pad area PDA1, a second pad area PDA2, and a third pad area PDA3 may be defined in a portion of the second area AA2 adjacent to the lower end of the second area AA2. The first pad area PDA1, the second pad area PDA2, and the third pad area PDA3 may extend in the second direction DR2, and may be arranged in the second direction DR2. The first pad area PDA1 may be located between the second pad area PDA2 and the third pad area PDA3.

The first pads PD1 may be located in the first pad area PDA1. The data driver DDV, the first power line PL1, the second power line PL2, the first control line CSL1, and the second control line CSL2 may be connected to the first pads PD1.

The data lines DL1 to DLn may be connected to the corresponding first pads PD1 through the data driver DDV. For example, the data lines DL1 to DLn may be connected to the data driver DDV, and the data driver DDV may be connected to the first pads PD1 corresponding to the data lines DL1 to DLn, respectively.

The printed circuit board PCB may be connected to the display layer 100. The timing controller T-CON and the sensor driver TIC may be located on the printed circuit board PCB. For example, the timing controller T-CON and the sensor driver TIC may each be manufactured as integrated circuit chips, and may be mounted on the printed circuit board PCB.

A first connection pad area CPA1, a second connection pad area CPA2, and a third connection pad area CPA3 may be defined in a portion of the printed circuit board PCB adjacent to one side of the printed circuit board PCB. The first connection pad area CPA1, the second connection pad area CPA2, and the third connection pad area CPA3 may extend in the second direction DR2, and may be arranged in the second direction DR2. The first connection pad area CPA1 may be located between the second connection pad area CPA2 and the third connection pad area CPA3.

First pads PCB-PD1 may be located in the first connection pad area CPA1, second pads PCB-PD2 may be located in the second connection pad area CPA2, and third pads PCB-PD3 may be located in the third connection pad area CPA3. The first pads PD1 may be connected to the first pads PCB-PD1. The first pads PCB-PD1 may be connected to the timing controller T-CON. The second pads PCB-PD2 and the third pads PCB-PD3 may be connected to the sensor driver TIC.

The timing controller T-CON may control the operations of the scan driver SDV, the data driver DDV, and the light-emitting driver EDV. The timing controller T-CON may generate a scan control signal, a data control signal, and a light-emitting control signal in response to control signals received from the outside.

The scan control signal may be provided to the scan driver SDV through the first control line CSL1. The light-emitting control signal may be provided to the light-emitting driver EDV through the second control line CSL2. The data control signal may be provided to the data driver DDV. The timing controller T-CON may receive image signals from the outside, convert the data format of the image signals to match interface specifications thereof with the data driver DDV, and may provide the image signals with a converted data format to the data driver DDV.

The scan driver SDV may generate a plurality of scan signals in response to the scan control signal. The scan signals may be applied to the pixels PX through the scan lines SL1 to SLm. The scan signals may be applied sequentially to the pixels PX.

The data driver DDV may generate a plurality of data voltages corresponding to image signals in response to the data control signal. The data voltages may be applied to the pixels PX through the data lines DL1 to DLn. The light-emitting driver EDV may generate a plurality of light-emitting signals in response to the light-emitting control signal. The light-emitting signals may be applied to the pixels PX through the light-emitting lines EL1 to ELm.

The pixels PX may receive the data voltages in response to the scan signals. The pixels PX may display the image IM (see FIG. 1) by emitting light with brightness corresponding to the data voltages in response to the light-emitting signals. The light-emitting time of the pixels PX may be controlled by the light-emitting signals.

FIG. 4 is a plan view of the input-sensing layer 200 according to one or more embodiments of the present disclosure.

Referring to FIG. 4, the input-sensing layer 200 may include a plurality of sensing electrodes SE, a plurality of lines SNL1 and SNL2, a plurality of multiplexer circuits MX, a plurality of second pads PD2, and a plurality of third pads PD3.

The planar area of the input-sensing layer 200 may include the first area AA1, the second area AA2, and the bending area BA, to be substantially identical to the display layer 100 (see FIG. 2).

The first area AA1 may include an active area AA, and a peripheral area NAA around the active area AA. The peripheral area NAA may surround the active area AA (e.g., in plan view).

When viewed on a plane, the active area AA may overlap the display area 100-DA (see FIG. 3), and the peripheral area NAA may overlap the non-display area 100-NDA (see FIG. 3).

The second area AA2 and the bending area BA may be defined as the peripheral area NAA.

The plurality of sensing electrodes SE may be located in the active area AA.

The plurality of second pads PD2 and the plurality of third pads PD3 may be located in the second area AA2.

The plurality of lines SNL1 and SNL2 may include a plurality of sensing lines SNL1 and a plurality of connection lines SNL2.

The plurality of sensing lines SNL1 may be respectively connected to the plurality of sensing electrodes SE, and may extend to the second area AA2 via the bending area BA. For example, when viewed on a plane, the plurality of sensing lines SNL1 may be connected to the right side of the plurality of sensing electrodes SE, respectively, and may extend in the first direction DR1. The plurality of sensing lines SNL1 may extend to the peripheral area NAA.

The plurality of connection lines SNL2 may be located in the second area AA2. The plurality of connection lines SNL2 may be located between the plurality of multiplexer circuits MX and the sensor driver TIC (see FIG. 4) to be connected thereto. The number of plurality of connection lines SNL2 may be fewer than the number of plurality of sensing lines SNL1. The plurality of connection lines SNL2 may be electrically connected to the plurality of second pads PD2 and the plurality of third pads PD3.

The plurality of sensing lines SNL1 and the plurality of connection lines SNL2 may be electrically connected to each other by the plurality of multiplexer circuits MX.

The plurality of second pads PD2 and the plurality of third pads PD3 may be connected to the second pads PCB-PD2 and the third pads PCB-PD3 (see FIG. 3), respectively. The sensor driver TIC (see FIG. 3) may control the operation of the input-sensing layer 200 through the plurality of second pads PD2 and the plurality of third pads PD3.

The plurality of sensing electrodes SE may have their own coordinate information. The plurality of sensing electrodes SE may be arranged along the first direction DR1 and the second direction DR2. For example, the plurality of sensing electrodes SE may be arranged in a matrix form. However, this is only an example and the arrangement of the plurality of sensing electrodes SE according to one or more embodiments of the present disclosure is not limited thereto.

The plurality of sensing electrodes SE may be respectively connected to the plurality of sensing lines SNL1.

Each of the plurality of sensing electrodes SE may operate in a self-capacitance mode. For example, the sensor driver TIC (see FIG. 3) may operate each of the plurality of sensing electrodes SE as a driving electrode and a sensing electrode. The sensor driver TIC (see FIG. 3) may apply a driving signal to each of the plurality of sensing electrodes SE through the plurality of lines SNL1 and SNL2, and may receive a sensing signal from each of the plurality of sensing electrodes SE. This will be described later.

The plurality of multiplexer circuits MX may be located in the second area AA2. The plurality of multiplexer circuits MX may be located between the plurality of sensing lines SNL1 and the plurality of connection lines SNL2. The plurality of multiplexer circuits MX may be adjacent to the bending area BA.

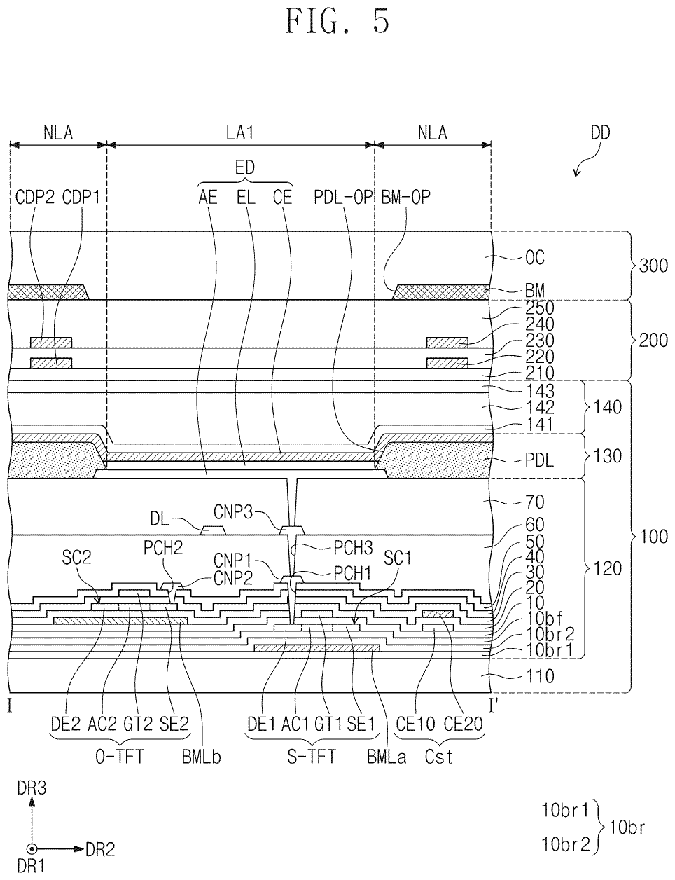

FIG. 5 is a cross-sectional view of the electronic device ED according to one or more embodiments of the present disclosure.

Referring to FIG. 5, a barrier layer 10br may be located on the base layer 110 (as used herein, “located on” may mean “above”). The barrier layer 10br reduces or prevents foreign substances from entering from outside. The barrier layer 10br may include at least one inorganic layer. The barrier layer 10br may include a silicon oxide layer and a silicon nitride layer. The silicon oxide layer and the silicon nitride layer may include a plurality of silicon oxide layers and a plurality of silicon nitride layers, and the silicon oxide layers and the silicon nitride layers may be alternately stacked.

The barrier layer 10br may include a lower barrier layer 10br1 and an upper barrier layer 10br2. A first shielding electrode BMLa may be located between the lower barrier layer 10br1 and the upper barrier layer 10br2. The first shielding electrode BMLa may be located to correspond to a silicon transistor S-TFT. The first shielding electrode BMLa may include a metal, for example, molybdenum.

The first shielding electrode BMLa may receive a bias voltage. The first shielding electrode BMLa may also receive a first power voltage. The first shielding electrode BMLa may block electric potential caused by polarization from affecting the silicon transistor S-TFT. The first shielding electrode BMLa may block external light from reaching the silicon transistor S-TFT. In one or more embodiments of the present disclosure, the first shielding electrode BMLa may be a floating electrode, isolated from other electrodes or wiring.

A buffer layer 10bf may be located on the barrier layer 10br. The buffer layer 10bf may reduce or prevent metal atoms or impurities diffusing from the base layer 110 upward to a first semiconductor pattern SC1. The buffer layer 10bf may contain at least one inorganic layer. The buffer layer 10bf may include a silicon oxide layer and a silicon nitride layer.

The first semiconductor pattern SC1 may be located on the buffer layer 10bf. The first semiconductor pattern SC1 may include a silicon semiconductor. For example, the silicon semiconductor may include amorphous silicon, polycrystalline silicon, etc. For example, the first semiconductor pattern SC1 may include low-temperature polysilicon.

The first semiconductor pattern SC1 may have different electrical properties depending on doping. The first semiconductor pattern SC1 may include a first area with high conductivity, and a second area with low conductivity. The first area may be doped with an N-type dopant or a P-type dopant. The second area may be an undoped area or an area doped at a lower concentration compared to the first area. A source area SE1, a channel area AC1 (or an active area), and a drain area DE1 of the silicon transistor S-TFT may be formed from the first semiconductor pattern SC1. The source area SE1 and the drain area DE1 may extend in opposite directions from the channel area AC1 in a cross section.

A first insulating layer 10 may be located on the buffer layer 10bf. The first insulating layer 10 may cover the first semiconductor pattern SC1. The first insulating layer 10 may be an inorganic layer. The first insulating layer 10 may be a single layer of silicon oxide. The inorganic layer of the driving element layer 120 to be described later, as well as the inorganic layer of the first insulating layer 10, may have a single-layer or multi-layer structure, and may include at least one of the materials described above, but is not limited thereto.

A gate GT1 of the silicon transistor S-TFT is located on the first insulating layer 10. The gate GT1 may be a part of a metal pattern. The gate GT1 overlaps the channel area AC1. In the process of doping the first semiconductor pattern SC1, the gate GT1 may be a mask. A first electrode CE10 of a storage capacitance Cst is placed on the first insulating layer 10. Unlike the first electrode CE10 illustrated in FIG. 5, the first electrode CE10 may have an integral shape with the gate GT1.

A second insulating layer 20 may be located on the first insulating layer 10 and may cover the gate GT1. In one or more embodiments of the present disclosure, an upper electrode overlapping the gate GT1 may be arranged on the second insulating layer 20. A second electrode CE20 overlapping the first electrode CE10 may be located on the second insulating layer 20. The upper electrode may have an integral shape with the second electrode CE20 on a plane.

A second shielding electrode BMLb is located on the second insulating layer 20. The second shielding electrode BMLb may be located to correspond to an oxide transistor O-TFT. In one or more embodiments of the present disclosure, the second shielding electrode BMLb may be omitted. According to one or more embodiments of the present disclosure, the first shielding electrode BMLa may extend to the lower part of the oxide transistor O-TFT, and may replace the second shielding electrode BMLb.

A third insulating layer 30 may be located on the second insulating layer 20. A second semiconductor pattern SC2 may be located on the third insulating layer 30. The second semiconductor pattern SC2 may include a channel area AC2 of the oxide transistor O-TFT. The second semiconductor pattern SC2 may include a metal oxide semiconductor. The second semiconductor pattern SC2 may include a transparent conductive oxide (TCO), such as an indium tin oxide (ITO), an indium zinc oxide (IZO), an indium gallium zinc oxide (IGZO), a zinc oxide (ZnOx), or an indium oxide (In2O3).

The metal oxide semiconductor may include a plurality of areas SE2, AC2, and DE2 distinguished depending on whether the transparent conductive oxide is reduced or not. An area (hereinafter, referred to as a reduced area) where the transparent conductive oxide is reduced has greater conductivity than an area (hereinafter, referred to as a non-reduced area) where the transparent conductive oxide is not reduced. The reduced area substantially acts as the source/drain of a transistor or as a signal line. The non-reduced area substantially corresponds to the semiconductor area (or channel) of the transistor. A fourth insulating layer 40 may be located on the third insulating layer 30. As illustrated in FIG. 5, the fourth insulating layer 40 may cover the second semiconductor pattern SC2. In one or more embodiments of the present disclosure, the fourth insulating layer 40 may be an insulating pattern that overlaps the gate GT2 of the oxide transistor O-TFT, and that exposes a source area SE2 and a drain area DE2 of the oxide transistor O-TFT.

The gate GT2 of the oxide transistor O-TFT is located on the fourth insulating layer 40. The gate GT2 of the oxide transistor O-TFT may be a part of the metal pattern. The gate GT2 of the oxide transistor O-TFT overlaps the channel area AC2. A fifth insulating layer 50 may be located on the fourth insulating layer 40, and may cover the gate GT2. Each of the first insulating layer 10 to the fifth insulating layer 50 may be an inorganic layer.

A first connection pattern CNP1 and a second connection pattern CNP2 may be located on the fifth insulating layer 50. The first connection pattern CNP1 and the second connection pattern CNP2 may be formed through the same process, and thus may have identical materials and identical stacked structures. The first connection pattern CNP1 may be connected to the drain area DE1 of the silicon transistor S-TFT through a first pixel contact hole PCH1 that penetrates the first to fifth insulating layers 10, 20, 30, 40, and 50. The second connection pattern CNP2 may be connected to the source area SE2 of the oxide transistor O-TFT through a second pixel contact hole PCH2 that penetrates the fourth insulating layer 40 and the fifth insulating layer 50. The connection relationships of the first connection pattern CNP1 and the second connection pattern CNP2 with the silicon transistor S-TFT and the oxide transistor O-TFT are not necessarily limited thereto.

A sixth insulating layer 60 may be located on the fifth insulating layer 50. A third connection pattern CNP3 may be located on the sixth insulating layer 60. The third connection pattern CNP3 may be connected to the first connection pattern CNP1 through a third pixel contact hole PCH3 that penetrates the sixth insulating layer 60. The data line DL may be located on the sixth insulating layer 60. A seventh insulating layer 70 may be located on the sixth insulating layer 60, and may cover the third connection pattern CNP3 and the data line DL. The third connection pattern CNP3 and the data line DL may be formed through the same process, and thus may have identical materials and identical stacked structures. Each of the sixth insulating layer 60 and the seventh insulating layer 70 may be an organic layer.

A light-emitting element ED may include a first electrode AE, a first light-emitting layer EL, and a cathode CE. An anode AE of the light-emitting element ED may be located on the seventh insulating layer 70. The anode AE may be a (semi) transparent electrode or a reflective electrode. The anode AE may include a sequentially stacked structure of ITO/Ag/ITO. The positions of the anode AE and the cathode CE may be interchanged.

A pixel-defining film PDL may be located on the seventh insulating layer 70. The pixel-defining film PDL may be an organic layer. The pixel-defining film PDL may have light-absorbing properties. For example, the pixel-defining film PDL may have a black color. The pixel-defining film PDL may include a black coloring agent. The black coloring agent may include black dye and black pigment. The black coloring agent may contain carbon black, a metal, such as chromium, or an oxide thereof. The pixel-defining film PDL may correspond to the light-blocking pattern having light-blocking properties.

The pixel-defining film PDL may cover a portion of the anode AE. For example, an opening part PDL-OP that exposes a portion of the anode AE may be defined in the pixel-defining film PDL. A light-emitting area LA1 may be defined to correspond to the opening part PDL-OP. The opening part PDL-OP of the pixel-defining film PDL may be described as a “light-emitting opening part.” The light-emitting opening part PDL-OP may expose at least a portion of the first electrode AE of the light-emitting element ED.

The light-emitting layer EL may be located on the first electrode AE and the pixel-defining film PDL. The light-emitting layer EL may be located in the opening part PDL-OP. The light-emitting layer EL may overlap the light-emitting opening part PDL-OP, and may be located on the first electrode AE of the light-emitting element ED.

The cathode CE may be located on the light-emitting layer EL and the pixel-defining film PDL. The cathode CE may overlap the light-emitting opening part PDL-OP. The cathode CE of the light-emitting element ED may overlap the light-emitting opening part PDL-OP, and may be located on the light-emitting layer EL.

In FIG. 5, the light-emitting layer EL is illustrated to be arranged on the first electrode AE of the light-emitting elements ED and the pixel-defining film PDL, but is not limited thereto. For example, the light-emitting layers EL may be located only on the first electrode AE of the light-emitting element ED.

In one or more embodiments of the present disclosure, a hole control layer may be located between the anode AE and the light-emitting layer EL. The hole control layer includes a hole transport layer, and may further include a hole injection layer. An electron control layer may be located between the light-emitting layer EL and the cathode CE. The electron control layer includes an electron transport layer, and may further include an electron injection layer.

The encapsulation layer 140 may cover the light-emitting element ED. The encapsulation layer 140 may include an encapsulation inorganic layer 141, an encapsulation organic layer 142, and an encapsulation inorganic layer 143, which are sequentially stacked, but the layers constituting the encapsulation layer 140 are not necessarily limited thereto. Each of the encapsulation inorganic layers 141 and 143 may include a silicon nitride layer, a silicon oxynitride layer, a silicon oxide layer, a titanium oxide layer, or an aluminum oxide layer, etc. Each of the encapsulation inorganic layers 141 and 143 may have a multilayer structure. The encapsulation organic layer 142 may include an acrylic-based organic layer, but is not limited thereto.

The input-sensing layer 200 contains a plurality of conductive patterns. The input-sensing layer 200 may include at least one conductive layer (or at least one sensor conductive layer) including the plurality of conductive patterns, and at least one insulating layer (or at least one sensor insulating layer). The input-sensing layer 200 may include a first sensor insulating layer 210, a first sensor conductive layer 220, a second sensor insulating layer 230, a second sensor conductive layer 240, and a third sensor insulating layer 250. In FIG. 4, a plurality of conductive patterns included in each of the first sensor conductive layer 220 and the second sensor conductive layer 240 are simply illustrated.

The first sensor insulating layer 210 may be located directly on the display layer 100. The first sensor insulating layer 210 may be located directly on the encapsulation layer 140. The first sensor insulating layer 210 may be located between the encapsulation layer 140 and the first sensor conductive layer 220. The first sensor insulating layer 210 may be an inorganic layer including at least one of silicon nitride, silicon oxynitride, or silicon oxide. The first sensor insulating layer 210 may be omitted.

The first sensor conductive layer 220 may be located on the encapsulation layer 140. The first sensor conductive layer 220 may include a plurality of first conductive patterns CDP1 spaced apart from each other. The first conductive patterns CDP1 may correspond to the sensing electrodes to be described later. Each of the first conductive patterns CDP1 may include a plurality of mesh lines. The first conductive patterns CDP1 are illustrated as a part of the mesh lines. However, this is described as an example, and the first conductive patterns CDP1 may be transparent electrodes, or may have an integral pattern shape overlapping the light-emitting area LA1, and are not limited to any given embodiments.

The second sensor conductive layer 240 may be located on the first sensor conductive layer 220. The second sensor conductive layer 240 may include a plurality of second conductive patterns CDP2 spaced apart from each other. The second conductive patterns CDP2 may correspond to auxiliary electrodes to be described later. The second conductive patterns CDP2 may have shapes corresponding to the first conductive patterns CDP1. Each of the second conductive patterns CDP2 may include a plurality of mesh lines. The second conductive patterns CDP2 may be transparent electrodes, or may have an integral pattern shape overlapping the light-emitting area LA1, and are not limited to any given embodiments.

The first sensor conductive layer 220 and the second sensor conductive layer 240 of single-layer structures may include a metal layer or a transparent conductive layer. The metal layer may include molybdenum, silver, titanium, copper, aluminum, or an alloy thereof. The transparent conductive layer may include a transparent conductive oxide, such as an indium tin oxide (ITO), an indium zinc oxide (IZO), a zinc oxide (ZnOx), or an indium zinc tin oxide (IZTO). In addition, the transparent conductive layer may include a conductive polymer, such as PEDOT, metal nanoline, graphene, etc.

The first sensor conductive layer 220 and the second sensor conductive layer 240 of multilayer structures may include a plurality of metal layers. The metal layers may, for example, have a three-layer structure titanium/aluminum/titanium. Alternatively, the multilayer conductive layer may include at least one metal layer and at least one transparent conductive layer.

The second sensor insulating layer 230 may be located between the first sensor conductive layer 220 and the second sensor conductive layer 240. The second sensor insulating layer 230 may be located between the encapsulation layer 140 and the second sensor conductive layer 240, and may be located on the first sensor insulating layer 210. The second sensor insulating layer 230 may cover the plurality of first conductive patterns included in the first sensor conductive layer 220. The second sensor insulating layer 230 may include at least one of silicon nitride, a silicon oxide, silicon oxynitride, or an aluminum oxide. In this case, the second sensor insulating layer 230 may be provided as a plurality of inorganic layers. However, the second sensor insulating layer 230 is not limited to one or more embodiments, but may include an organic insulating material. In this case, the second sensor insulating layer 230 may be provided as a single layer. That is, the second sensor insulating layer 230 may include an inorganic layer or an organic layer.

The third sensor insulating layer 250 (or a sensor cover layer) may cover the plurality of second conductive patterns included in the second sensor conductive layer 240. In one or more embodiments of the present disclosure, the third sensor insulating layer 250 (or the sensor cover layer) may be omitted. The third sensor insulating layer 250 may be replaced with the insulating layer of the optical layer 300 located on an adhesive layer or the input-sensing layer 200. The second sensor insulating layer 230 and the third sensor insulating layer 250 (or the sensor cover layer) may include an inorganic layer or an organic layer.

The optical layer 300 may be located on the input-sensing layer 200. The optical layer 300 may include a light-blocking layer BM, and a planarization layer OC. The optical layer 300 may reduce the reflectivity of light incident from the outside of the display layer 100 (see FIG. 3), thereby improving the visibility of the external light of the display layer 100 (see FIG. 3).

A material constituting the light-blocking layer BM is not particularly limited as long as the material is a material that absorbs light. The light-blocking layer BM is a layer having a black color, and in one or more embodiments, may include a black coloring agent. The black coloring agent may include black dye and black pigment. The black coloring agent may include carbon black, metal, such as chromium, or an oxide thereof.

The light-blocking layer BM may overlap the first conductive patterns CDP1 and the second conductive patterns CDP2 on a plane. The light-blocking layer BM may reduce or prevent external light reflection caused by the first conductive patterns CDP1 and the second conductive patterns CDP2. Light-blocking openings BM-OP may be defined in the light-blocking layer BM. The light-blocking openings BM-OP of the light-blocking layer BM may overlap the anode AE, and may have a larger area than the light-emitting opening parts PDL-OP of the pixel-defining film PDL.

The planarization layer OC may cover the light-blocking layer BM. The planarization layer OC may include organic matter, and the planarization layer OC may provide a flat upper surface.

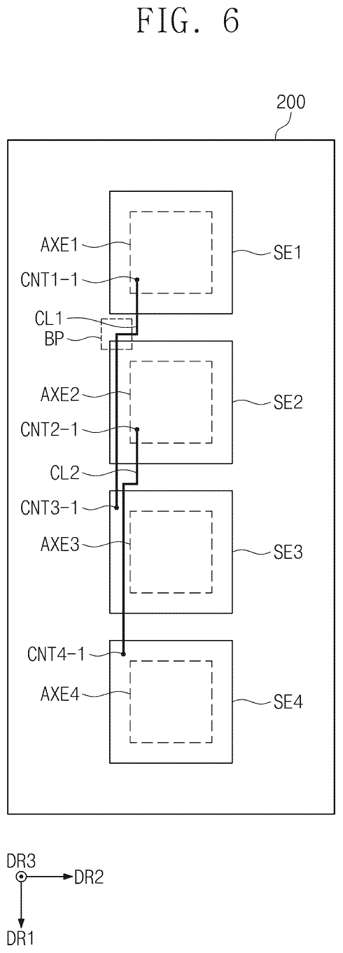

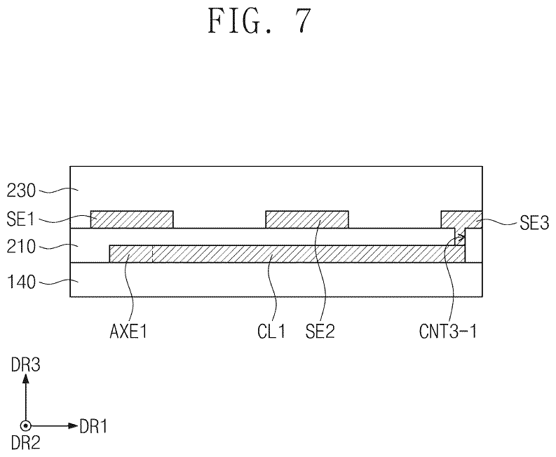

FIG. 6 is an enlarged view of a portion of the input-sensing layer 200 according to one or more embodiments of the present disclosure. FIG. 7 is a cross-sectional view of the electronic device ED according to one or more embodiments of the present disclosure.

Referring to FIGS. 6 and 7, the input-sensing layer 200 according to one or more embodiments of the present disclosure may include the plurality of sensing electrodes SE, the plurality of auxiliary electrodes AXE, and a plurality of connection lines CL1 and CL2. FIG. 6 illustrates four sensing electrodes SE1 to SE4 (hereinafter, first to fourth sensing electrodes), four auxiliary electrodes AXE1 to AXE4 (hereinafter, first to fourth auxiliary electrodes), and the two connection lines CL1 and CL2 (hereinafter, a first connection line and a second connection line).

The first to fourth sensing electrodes SE1, SE2, SE3, and SE4 may be arranged along one direction. The first to fourth sensing electrodes SE1, SE2, SE3, and SE4 may be arranged to be spaced apart from each other along the first direction DR1. The first to fourth sensing electrodes SE1, SE2, SE3, and SE4 may constitute the second sensor conductive layer 240 described above. Accordingly, the first to fourth sensing electrodes SE1, SE2, SE3, and SE4 may correspond to the second conductive patterns CDP2 (see FIG. 5) described above.

The first to fourth auxiliary electrodes AXE1, AXE2, AXE3, and AXE4 may be arranged along one direction. The first to fourth auxiliary electrodes AXE1, AXE2, AXE3, and AXE4 may be arranged to be spaced apart from each other along the first direction DR1. The first to fourth auxiliary electrodes AXE1, AXE2, AXE3, and AXE4 may constitute the first sensor conductive layer 220 (see FIG. 5) described above.

The first to fourth auxiliary electrodes AXE1, AXE2, AXE3, and AXE4 may be arranged at positions that overlap the first to fourth sensing electrodes SE1, SE2, SE3, and SE4, respectively, on a plane. Any one auxiliary electrode of the first to fourth auxiliary electrodes AXE1, AXE2, AXE3, and AXE4 may overlap at least a portion of a corresponding sensing electrode among the first to fourth sensing electrodes SE1, SE2, SE3, and SE4. The area of each of the first to fourth auxiliary electrodes AXE1, AXE2, AXE3, and AXE4 on a plane may be smaller than the area of a corresponding sensing electrode, on a plane, among the first to fourth sensing electrodes SE1, SE2, SE3, and SE4. Meanwhile, each of the first to fourth auxiliary electrodes AXE1, AXE2, AXE3, and AXE4 and the first to fourth sensing electrodes SE1, SE2, SE3, and SE4 is illustrated to have a quadrangular shape. However, this is illustrated only as an example, and the shape of each of the first to fourth auxiliary electrodes AXE1, AXE2, AXE3, and AXE4 and the first to fourth sensing electrodes SE1, SE2, SE3, and SE4 may be a polygonal shape or a circular shape, and is not limited to any given embodiments. In addition, as long as the first to fourth auxiliary electrodes AXE1, AXE2, AXE3, and AXE4 are able to overlap the first to fourth sensing electrodes SE1, SE2, SE3, and SE4, respectively, on a plane, the first to fourth auxiliary electrodes AXE1, AXE2, AXE3, and AXE4 may have shapes that are different from the first to fourth sensing electrodes SE1, SE2, SE3, and SE4, respectively, and are not limited to any given embodiments.

Each of the first connection line CL1 and the second connection line CL2 may extend along the first direction DR1. Each of the first connection line CL1 and the second connection line CL2 may connect one sensing electrode and one auxiliary electrode to each other. One sensing electrode and one auxiliary electrode may be electrodes spaced apart from each other in the first direction DR1, and may not overlap each other on a plane.

The first connection line CL1 may connect the first auxiliary electrode AXE1 with the third sensing electrode SE3. The first auxiliary electrode AXE1 and the third sensing electrode SE3 may be electrically connected to each other by the first connection line CL1. The second connection line CL2 may connect the second auxiliary electrode AXE2 with the fourth sensing electrode SE4. The second auxiliary electrode AXE2 and the fourth sensing electrode SE4 are electrically connected to each other by the second connection line CL2.

The second connection line CL2 may be spaced apart from the first connection line CL1 in the second direction DR2 on a plane. The first connection line CL1 and the second connection line CL2 may be electrically insulated. The first connection line CL1 and the second connection line CL2 may transmit electrical signals independent of each other. The first connection line CL1 and the second connection line CL2 may be located on the same layer. The first connection line CL1 and the second connection line CL2 may constitute the first sensor conductive layer 220. That is, each of the first connection line CL1 and the second connection line CL2 may be one of the first conductive patterns CDP1.

The third sensing electrode SE3, which is arranged in the second sensor conductive layer 240, may penetrate the first sensor insulating layer 210 (see FIG. 5) and may be connected to the first connection line CL1. The third sensing electrode SE3 and the first connection line CL1 may be in contact with each other through a 3-1 through hole CNT3-1 formed in the first sensor insulating layer 210. The same electrical signal as that of the third sensing electrode SE3 may be applied to the first auxiliary electrode AXE1, which is spaced apart from the third sensing electrode SE3 on a plane, through the first connection line CL1. Accordingly, the first sensing electrode SE1 may be spaced apart from each of the second sensing electrode SE2 and the third sensing electrode SE3 with the first sensor insulating layer 210 placed therebetween to form capacitance. Accordingly, the sensitivity of the input-sensing layer 200 may be improved. A detailed description of this will be provided later.

The fourth sensing electrode SE4, which is arranged in the second sensor conductive layer 240, may penetrate the first sensor insulating layer 210, and may be connected to the second connection line CL2. The fourth sensing electrode SE4 and the second connection line CL2 may be in contact with each other through a 4-1 through hole CNT4-1 formed in the first sensor insulating layer 210. The same electrical signal as that of the fourth sensing electrode SE4 may be applied to the second auxiliary electrode AXE2, which is spaced apart from the fourth sensing electrode SE4 on a plane, through the second connection line CL2. Accordingly, the second sensing electrode SE2 may be spaced apart from each of the adjacent first sensing electrode SE1, the third sensing electrode SE3, and the fourth sensing electrode SE4 with the first sensor insulating layer 210 placed therebetween to form capacitance. Accordingly, the sensitivity of the input-sensing layer 200 may be improved. A detailed description of this will be provided later.

The connection lines CL1 and CL2 may include at least one bent portion BP. Accordingly, the connection lines CL1 and CL2 may be formed in shapes that do not interfere with other adjacent auxiliary electrodes. For example, the first connection line CL1 may be connected to the third sensing electrode SE3 via an area that does not overlap the second auxiliary electrode AXE2 by further including the bent portion BP. However, this is merely an example, and as long as the connection lines CL1 and CL2 do not affect other adjacent auxiliary electrodes, the bent portion BP in each of the connection lines CL1 and CL2 may be omitted or provided in a different shape, and is not limited to any given embodiments.

In addition, the connection lines CL1 and CL2 may overlap the first to fourth sensing electrodes SE1, SE2, SE3, and SE4 on a plane. Because the connection lines CL1 and CL2 are located on different layers from the first to fourth sensing electrodes SE1, SE2, SE3, and SE4, the connection lines CL1 and CL2 may be arranged in an area overlapping an area where the first to fourth sensing electrodes SE1, SE2, SE3, and SE4 are located without interference with the first to fourth sensing electrodes SE1, SE2, SE3, and SE4. Accordingly, it is possible to reduce or prevent the reduction of separation space between the first to fourth sensing electrodes SE1, SE2, SE3, and SE4 and the reduction of the number of the first to fourth sensing electrodes SE1, SE2, SE3, and SE4 within an effective area. However, this is only an example, and the connection lines CL1 and CL2 may be formed at positions that do not overlap the first to fourth sensing electrodes SE1, SE2, SE3, and SE4, or at positions that overlap sensing electrodes in other adjacent columns, and are not limited to any given embodiments.

The bent portion BP may include a first part extending in the second direction DR2, and a second part connected to the first part and extending in the first direction DR1. At least a portion of the second part may overlap the second sensing electrode SE2 and/or the fourth sensing electrode SE4. However, embodiments are not limited thereto, and the second part of the bent portion BP may not overlap the second sensing electrode SE2. Accordingly, the number of sensing electrodes SE arranged in the input-sensing layer 200 may increase, and the electronic device ED with improved touch sensitivity may be provided.

The connection lines CL1 and CL2 and the first to fourth auxiliary electrodes AXE1, AXE2, AXE3, and AXE4 may be located on an identical layer. The connection lines CL1 and CL2 may include the same material as the first to fourth auxiliary electrodes AXE1, AXE2, AXE3, and AXE4. The connection lines CL1 and CL2 may be formed through the same process as the first to fourth auxiliary electrodes AXE1, AXE2, AXE3, and AXE4. Accordingly, time and costs required for the process may be reduced.

The areas of the first to fourth sensing electrodes SE1, SE2, SE3, and SE4 may be equal to each other. The first to fourth sensing electrodes SE1, SE2, SE3, and SE4 may operate in a self-capacitance mode.

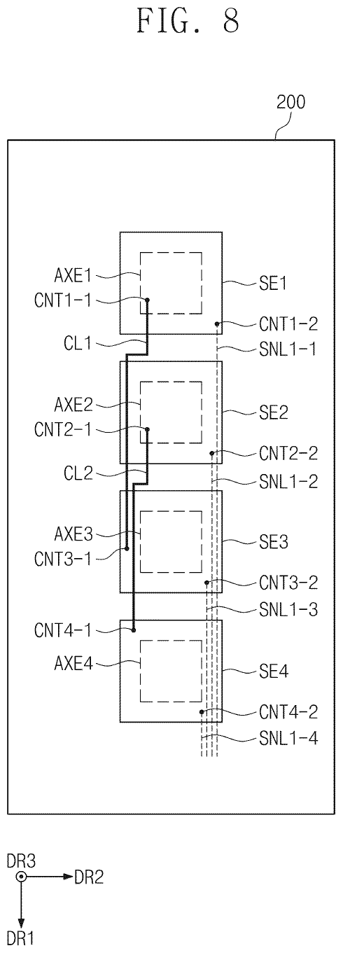

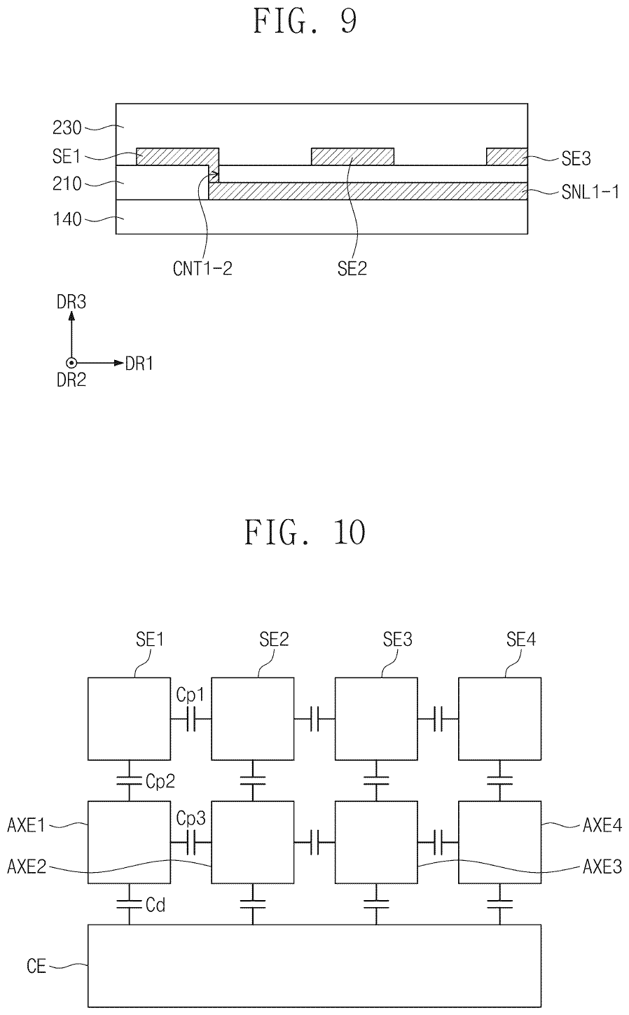

FIG. 8 is an enlarged view of a portion of the input-sensing layer 200 according to one or more embodiments of the present disclosure. FIG. 9 is a cross-sectional view of the electronic device ED according to one or more embodiments of the present disclosure. Hereinafter, in a description with reference to FIGS. 8 and 9, the same/similar reference numerals are used for the same/similar components as those described in FIGS. 6 and 7, and duplicate descriptions are omitted.

Referring to FIGS. 8 and 9, the input-sensing layer 200 may include a plurality of sensing lines SNL1-1, SNL1-2, SNL1-3, and SNL1-4 that are spaced apart from each other. FIG. 8 illustrates one or more embodiments in which the plurality of sensing lines SNL1-1, SNL1-2, SNL1-3, and SNL1-4 are located on the same layer as the first to fourth auxiliary electrodes AXE1, AXE2, AXE3, and AXE4, and are marked in dotted lines. However, this is only an example, and embodiments are not limited thereto. In one or more embodiments, the plurality of sensing lines SNL1-1, SNL1-2, SNL1-3, and SNL1-4 may be connected to the first to fourth sensing electrodes SE1, SE2, SE3, and SE4, respectively, without contact holes CNT1-2, CNT2-2, CNT3-2, and CNT4-2. The plurality of sensing lines SNL1-1, SNL1-2, SNL1-3, and SNL1-4 may be connected to the first to fourth sensing electrodes SE1, SE2, SE3, and SE4, respectively. The first sensing line SNL1-1 may be connected to the multiplexer circuits MX through the 1-2 contact hole CNT1-2 penetrating the first sensor insulating layer 210. The second sensing line SNL1-2 may be connected to the multiplexer circuits MX through the 2-2 contact hole CNT2-2 penetrating the first sensor insulating layer 210. The third sensing line SNL1-3 may be connected to the multiplexer circuits MX through the 3-2 contact hole CNT3-2 penetrating the first sensor insulating layer 210. The fourth sensing line SNL1-4 may be connected to the multiplexer circuits MX through the 4-2 contact hole CNT4-2 penetrating the first sensor insulating layer 210. The plurality of sensing lines SNL1-1, SNL1-2, SNL1-3, and SNL1-4 may overlap the first to fourth sensing electrodes SE1, SE2, SE3, and SE4. However, embodiments are not limited thereto, and the plurality of sensing lines SNL1-1, SNL1-2, SNL1-3, and SNL1-4 may include portions that do not overlap the first to fourth sensing electrodes SE1, SE2, SE3, and SE4.

FIG. 10 is a schematic diagram illustrating a sensor structure of the electronic device ED according to one or more embodiments of the present disclosure. Hereinafter, in a description with reference to FIG. 10, the same/similar reference numerals are used for the same/similar components as those described in FIGS. 6 to 9, and duplicate descriptions are omitted.

Referring to FIG. 10, the first to fourth auxiliary electrodes AXE1, AXE2, AXE3, and AXE4 constitute the first sensor conductive layer 220, and the first to fourth sensing electrodes SE1, SE2, SE3, and SE4 constitute the second sensor conductive layer 240, and thus the first to fourth auxiliary electrodes AXE1, AXE2, AXE3, and AXE4 may be located under the first to fourth sensing electrodes SE1, SE2, SE3, and SE4. The first to fourth auxiliary electrodes AXE1, AXE2, AXE3, and AXE4 are added between the first to fourth sensing electrodes SE1, SE2, SE3, and SE4 and the cathode CE, so the electrical influence of the cathode CE on the first to fourth sensing electrodes SE1, SE2, SE3, and SE4 may be reduced. Therefore, noise generation may be reduced.

In addition, one sensing electrode SE may not only form capacitance in relation to another adjacent sensing electrode SE, but also may further form capacitance in relation to an adjacent auxiliary electrode AXE. Therefore, the sensing sensitivity of each sensing electrode SE may be improved.

First capacitance Cp1 may be formed between adjacent sensing electrodes SE. Second capacitance Cp2 may be formed between each of the adjacent auxiliary electrodes AXE and each of the sensing electrodes SE. Third capacitance Cp3 may be formed between the adjacent auxiliary electrodes AXE. The auxiliary electrodes

AXE are further located between the first to fourth sensing electrodes SE1, SE2, SE3, and SE4 and the cathode CE, and thus capacitance may further be formed between the auxiliary electrodes AXE and the sensing electrodes SE, which are adjacent. Additionally, as the auxiliary electrodes AXE are additionally located, a distance between the sensing electrodes SE and the cathode CE increases, so capacitance between the sensing electrodes SE and the cathode CE may be reduced. As capacitance between the auxiliary electrodes AXE and the sensing electrodes SE increases, and as capacitance between the sensing electrodes SE and the cathode CE decreases, the touch sensitivity of the electronic device ED may be improved.

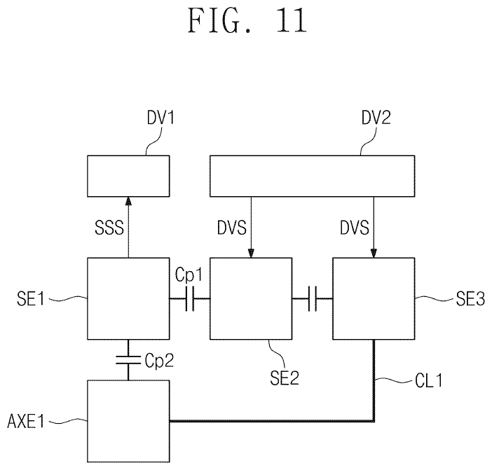

FIG. 11 is a block diagram illustrating the input-sensing layer 200 and a driver according to one or more embodiments of the present disclosure. Hereinafter, in a description with reference to FIG. 11, the same/similar reference numerals are used for the same/similar components as those described in FIGS. 6 to 10, and duplicate descriptions are not repeated.

Referring to FIG. 11, the first auxiliary electrode AXE1 may be connected to the third sensing electrode SE3 through the first connection line CL1. Accordingly, the first auxiliary electrode AXE1 and the third sensing electrode SE3 may be electrically connected to each other, and may be driven by the same electrical signal. When a sensing signal SSS is received from the first sensing electrode SE1, an identical driving signal DVS may be provided from a second sensor driver DV2 to the second sensing electrode SE2, to the third sensing electrode SE3, and to the first auxiliary electrode AXE1. A first sensor driver DV1 and the second sensor driver DV2 may be included in the sensor driver TIC (see FIG. 3) described above. When the sensing signal SSS is received from the first sensing electrode SE1, an identical driving voltage may be applied to each of the second sensing electrode SE2, the third sensing electrode SE3, and the first auxiliary electrode AXE1. According to the present disclosure, because the first auxiliary electrode AXE1 is connected to the third sensing electrode SE3 through the first connection line CL1, a driving voltage may be applied to the third sensing electrode SE3 so that the identical voltage may be applied to the first auxiliary electrode AXE1 adjacent to the first sensing electrode SE1. Accordingly, when the sensing signal SSS is detected, influence on the sensing signal SSS may be reduced due to the second sensing electrode SE2 or the first auxiliary electrode AXE1, which is adjacent.

By connecting the first auxiliary electrode AXE1 with the third sensing electrode SE3, the first auxiliary electrode AXE1 and the third sensing electrode SE3 are driven concurrently or substantially simultaneously, thereby providing the electronic device ED with improved touch sensitivity.

According to one or more embodiments of the present disclosure, the auxiliary electrodes may be additionally arranged in the input-sensing layer including the sensing electrodes that operate in a self-capacitance mode, thereby providing the electronic device with improved touch sensitivity.

While the present disclosure has been described with reference to embodiments thereof, it will be apparent to those of ordinary skill in the art that various changes and modifications may be made thereto without departing from the spirit and scope of the present disclosure as set forth in the following claims. Therefore, the technical scope of the present disclosure should not be limited to the contents described in the detailed description of the specification, but should be defined by the scope of the patent claims, with functional equivalents thereof to be included therein.

What is claimed is:

1. An electronic device comprising:
a first sensor conductive layer comprising first conductive patterns spaced apart from each other, and comprising:
a first auxiliary electrode, a second auxiliary electrode, and a third auxiliary electrode arranged along a first direction, and insulated electrically;
a connection line extending along the first direction, and connected to the first auxiliary electrode; and
sensing lines spaced apart from each other;
a second sensor conductive layer above the first sensor conductive layer, and comprising second conductive patterns spaced apart from each other and comprising a first sensing electrode, a second sensing electrode, and a third sensing electrode arranged along the first direction, insulated electrically, and respectively connected to the sensing lines, the third sensing electrode being connected to the connection line; and
a sensor insulating layer between the first sensor conductive layer and the second sensor conductive layer.

2. The electronic device of claim 1, wherein the first sensing electrode, the second sensing electrode, and the third sensing electrode respectively overlap the first auxiliary electrode, the second auxiliary electrode, and the third auxiliary electrode.

3. The electronic device of claim 2, wherein areas of the first sensing electrode, the second sensing electrode, and the third sensing electrode are larger than areas of the first auxiliary electrode, the second auxiliary electrode, and the third auxiliary electrode.

4. The electronic device of claim 1, wherein the first sensing electrode, the second sensing electrode, and the third sensing electrode are configured to operate in a self-capacitance mode.

5. The electronic device of claim 1, wherein the connection line comprises at least one bent portion, comprising:
a first part extending in a second direction crossing the first direction; and
a second part connected to the first part, extending in the first direction, and having at least a portion overlapping the second sensing electrode.

6. The electronic device of claim 1, wherein the connection line, the first auxiliary electrode, the second auxiliary electrode, and the third auxiliary electrode comprise a same material.

7. The electronic device of claim 1, wherein the connection line penetrates the sensor insulating layer, and is connected to the second conductive patterns.

8. The electronic device of claim 1, wherein the sensing lines respectively comprise portions that penetrate the sensor insulating layer, and that are respectively connected to the first sensing electrode, the second sensing electrode, and the third sensing electrode.

9. The electronic device of claim 1, wherein areas of the first sensing electrode, the second sensing electrode, and the third sensing electrode are identical.

10. The electronic device of claim 1, wherein an identical driving voltage is configured to be applied to the second sensing electrode, the third sensing electrode, and the first auxiliary electrode when the first sensing electrode is driven.

11. The electronic device of claim 1, wherein the first auxiliary electrode and the third sensing electrode are configured to be driven concurrently.

12. An electronic device comprising:
a first sensing electrode, a second sensing electrode, and a third sensing electrode at an identical layer, and arranged along one direction;
a first auxiliary electrode, a second auxiliary electrode, and a third auxiliary electrode at an identical layer, and arranged along the one direction;
a sensor insulating layer between the first sensing electrode and the first auxiliary electrode;
a connection line extending along the one direction, and connected to the first auxiliary electrode and the third sensing electrode; and
sensing lines respectively connected to the first sensing electrode, the second sensing electrode, and the third sensing electrode, and spaced apart from each other.

13. The electronic device of claim 12, wherein the connection line, the first auxiliary electrode, the second auxiliary electrode, and the third auxiliary electrode are at an identical layer.

14. The electronic device of claim 12, wherein the sensing lines, the connection line, the first auxiliary electrode, the second auxiliary electrode, and the third auxiliary electrode are at an identical layer.

15. The electronic device of claim 12, wherein the first auxiliary electrode, the second auxiliary electrode, and the third auxiliary electrode respectively partially overlap the first sensing electrode, the second sensing electrode, and the third sensing electrode.

16. The electronic device of claim 15, wherein areas of the first sensing electrode, the second sensing electrode, and the third sensing electrode are larger than areas of the first auxiliary electrode, the second auxiliary electrode, and the third auxiliary electrode.

17. The electronic device of claim 12, wherein the first sensing electrode, the second sensing electrode, and the third sensing electrode are configured to operate in a self-capacitance mode.

18. The electronic device of claim 12, wherein the connection line, the first auxiliary electrode, the second auxiliary electrode, and the third auxiliary electrode comprise a same material.

19. The electronic device of claim 12, wherein an identical driving voltage is configured to be applied to the second sensing electrode, the third sensing electrode, and the first auxiliary electrode when the first sensing electrode is driven.

20. The electronic device of claim 12, wherein the first auxiliary electrode and the third sensing electrode are configured to be driven concurrently.
